(19) United States
(12) Patent Application Publication
(10) Pub. No.: US 2012/0310823 A1
(43) Pub. Date: Dec. 6, 2012

(54) METHOD AND SYSTEM FOR OPERATING A SOCIAL FUNDING PLATFORM AND FOR INTERACTIVE FUNDRAISING IN A SOCIAL NETWORK ENVIRONMENT

(76) Inventors: Cornelius Colin McNab, Riverdale, GA (US); Harendra B. Jani, Stratford, CT (US)

(21) Appl. No.: 13/572,678

(22) Filed: Aug. 12, 2012

Related U.S. Application Data
(63) Continuation-in-part of application No. 12/484,411, filed on Jun. 15, 2009.
(60) Provisional application No. 61/523,284, filed on Aug. 13, 2011.

(51) Int. Cl. G06Q 40/00

(52) U.S. Cl. 705/39

(57) ABSTRACT

A social network fundraising system receives a business funding request associated with one or more traits from an entrepreneur/fundee. The system selects potential/candidate funders based at least partly on a ranking corresponding to their respective relationship to the fundee. The system sends a request message successively and preferentially to groups of one or more candidate funders according to the ranking order until funding offers are received from one or more candidate funders. The system sends received offers and information identifying the funders to the entrepreneur, and may facilitate automatic negotiation between each potential funder and the entrepreneur. The ranking order may correspond to statistical similarity between traits associated with a request and traits associated with a candidate funder, as well as to social similarity between the entrepreneur and candidate funder resulting from analysis of social network profiles. The system may facilitate displaying funding status on a funder's social network profile.

### CROSS REFERENCE TO RELATED APPLICATION

This application claims priority under 35 U.S.C. 119 to U.S. provisional patent application No. 61/523,284 filed on Aug. 13, 2011, entitled “Social funding platform and interactive fundraising in a social network environment,” which is incorporated herein by reference in its entirety. This application also claims priority under 35 U.S.C. 120 to U.S. patent application Ser. No. 12/484,411 filed on Jun. 15, 2009, entitled “Method and system for facilitating fundraising via a communication network,” which is incorporated herein by reference in its entirety.

### FIELD

Methods, systems, and apparatus, including computer programs encoded on a computer storage medium, for a social funding platform that utilizes social networking to facilitate business fundraising.

### BACKGROUND

This specification describes technologies relating to business fundraising and social networking services.

Traditionally, the basic paradigm in business financing has been the bank. While this paradigm has worked well in several contexts, it ignores another age-old model for raising money, which we call “the village paradigm.” In a village, savings and credit are obtained socially—money is transferred from person to person, and the financing task consists of finding the right people, rather than the right institution, to provide funding. Social funding networks facilitate direct funding relationships between friends, family, and social networks.

In a bank, entrepreneurs complete loan applications, the funds are generated by the bank's depositors before the loan applications, trust is based on credit score, and there are financial rewards based on interest rate. In a village, by contrast, entrepreneurs make funding requests with personal appeals, funds are provided in real-time by anyone in the community, trust is based on relationship, and the rewards may be financial or non-financial. For example, in many countries, a rotating savings and credit association (ROSCA) is a group of individuals who agree to meet in order to save and borrow together for a limited time. As an informal microfinance group, the individuals in the ROSCA select each other, which ensures that participation is based on trust and social forces, as well as a genuine commitment to participate. These properties have advantages for certain types of businesses—for example, early-stage businesses with no credit or collateral and small businesses in diverse industries tend to benefit from a wider range of funders who can make independent decisions and reduce individual risk by spreading it amongst a group. Often, a business may not qualify for bank funding until after it has exhausted alternative financing options, including funding through friends and family, to get through the early stages.

### SUMMARY

The embodiments described below can accommodate multiple funders, lenders, or investors and multiple fundees, fundraisers, entrepreneurs, borrowers, or businesses involved in a single transaction.

An aspect facilitates a social funding platform based on the village paradigm where individuals of a community have common characteristics and prefer to trust those who share such characteristics. Before the advent and widespread acceptance of social networking tools, it was nearly impossible for entrepreneurs to tap into micro-funding sources cost-effectively. An aspect applies innovative online tools to enable businesses to build social networks of friends and family members that facilitate raising capital through gifts, donations, loans, commercial paper, and equity investments. An aspect enables entrepreneurs to connect with friends and family and to raise critically needed early-stage and growth funds in an organized manner. Customers and clients, relatives, colleagues, friends, neighbors—everyday social and business contacts—can become funders of businesses.

An innovative aspect of the subject matter described in this specification can be embodied in methods that include the actions of receiving a funding request from a fundee in which the request is associated with one or more traits; selecting candidate funders based at least partly on each funder's respective relationship to the fundee; sending the request successively to groups of one or more candidate funders according to the ranking until funding offers are received from one or more of the candidate funders; and sending to the fundee the received funding offers and information that identifies the actual funders or candidate funders. Other embodiments of this aspect include corresponding systems, apparatus, and computer programs, configured to perform the actions of the methods, encoded on computer storage devices.

These and other embodiments can each optionally include one or more of the following features. Ranking candidate funders can be based at least partly on whether the potential funder has been contacted during a recent predetermined period or according to a contact frequency preference of the candidate funder. Identification of another potential funder can be received from a candidate funder, and the project invitation or funding request can be sent to the other candidate funder. The respective relationship rank of a candidate funder to the entrepreneur can be based at least partly on a measurement of social interaction between the candidate funder and the entrepreneur. One or more message formats appropriate for the one or more candidate funders in the one or more groups of one or more candidate funders can be selected and the project invitation or funding request can be sent using the selected message formats. The message format can be an HTML/XML electronic mail, a plain text electronic mail for viewing on mobile devices, an instant message, a text message via mobile SMS, an online post, or other social network message. The message format for a candidate funder in the one or more groups of one or more candidate funders can be selected based at least partly on a likelihood that the candidate funder will provide a funding offer based on the message format. The information can include ranking factor values or other description of a relationship between the entrepreneur and each funder. Ranking candidate funders can further comprise selecting one or more candidate funders based on traits associated with the selected candidate funders. The computer device can wait a request delay period, based on relationship ranking or target funding amount, between the sending of a project invitation or funding request to successive candidate funders.

As compared to traditional funding platforms, where the challenge lies in finding the right institution to satisfy a user's funding need, the challenge in a social funding platform lies in finding the right people to satisfy a user's funding need. Furthermore, while trust in a traditional funding institution is based on numerical underwriting criteria such as credit scores, in a social funding platform, trust is based on relationship.

Using a computer device, or devices, including communication networking equipment including computer servers, facilitates compiling, processing, evaluating, analyzing, and organizing potentially vast amounts of electronic data and information without biases, which human decision makers may place undue weight upon and thus make less than perfectly rational funding or investment decisions, either affirmatively or negatively with respect to offering to fund a fundraising project.

### BRIEF DESCRIPTION OF THE DRAWINGS

The above and other objects of the present invention will be apparent upon consideration of the following detailed descriptions, taken in conjunction with the accompanying drawings, in which like reference numerals refer to like parts throughout, and in which:

FIG. 1 illustrates system architecture of the social network fundraising system.

FIG. 2 illustrates a flow diagram of a statistical model that generates a relationship ranking that corresponds to a relationship between an entrepreneur and a candidate funder.

FIG. 3 is a flow diagram of a method for processing a fundraising project request and providing to candidate funders.

FIG. 4 illustrates a system for initiating a fundraising transaction.

FIG. 5 illustrates a system for facilitating an electronic fund transfer transaction.

### DETAILED DESCRIPTION

The present invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be more thorough, and will help convey the scope of the invention to those skilled in the art. Aspects of the present invention may be embodied as a method, financial management system, or computer program product. Furthermore, aspects of the invention may be targeted for use by individuals and groups, consumers and businesses.

In the following description of the preferred embodiment, reference is made to the accompanying figures that form a part hereof. It is to be understood that while the example of an entrepreneur and investor is used, other embodiments for the fundee and funder may be utilized without departing from the scope of the present invention.

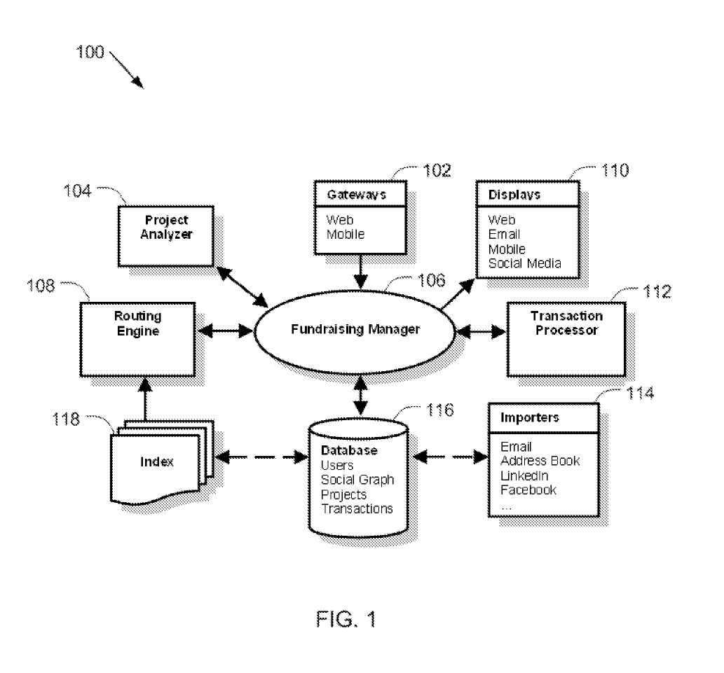

FIG. 1 illustrates an example of the system architecture of the social network fundraising system 100. Some components, each of which may be embodied in computer hardware, software, wireless mobile devices, or a combination thereof, of the system 100 architecture include fundraising manager 106, social network indexer 118, project analyzer 104, ranking function with routing engine 108, transaction processor 112, and user interface displays 110. System 100 may connect to a variety of communication networks through appropriate gateways 102. Social network indexer 118 finds and labels sources of funding—in this case, users who may be potential funders. Project analyzer 104 characterizes the project's funding needs and objectives and a likelihood of success or ability to repay an investor. A ranking function, preferably performed with routing engine 108, identifies sources most likely to provide the funding, and the ranking function generates a funding probability score corresponding to a candidate funder based on various data and information associated with the candidate funder, including information obtained from social networking internet sites, portals, databases, and the like. Transaction processor 112 processes online payments and updates account information, including transactions of an entrepreneur that has received proceeds from an funder/investor in response to a fundraising project invitation or funding request. User interface 110 generates a presentation of the project and funding information, formatted for display to a user on a user device, in an accessible and interactive form. A user may include a candidate funder, a funder who has made an offer to provide funding, a funder/investor that has transferred funds to an entrepreneur that has requested funding, the fundee/entrepreneur himself, or the fundee/entrepreneur's agent or representative. Various user interface display generators 110 accommodate existing, and future, communication channels that people use: For example, email, Web (including mobile), Simple Message Service (“SMS” or “text message”), Instant messaging (“IM”), and social media/network messaging, etc. System 100 may add context, including information about the users' relationship or common location that can facilitate trust, when sending invitations or other message communications from one user to another. For example, a fundraising project request message processed by system 100 may indicate that the requesting user (i.e., individual, group, or entity requesting funding) is a coworker in the same city and State, and the message/request includes a link to the user's profile on the social network fundraising system's website.

When a new user first joins a fundraising network, for example as facilitated by a computer network system such as operated by 40Billion.com, Inc., the social network fundraising system 100 performs a number of indexing steps to determine how to direct the appropriate projects to her as a potential funder.

Because projects in the social network fundraising system are routed to the user's extended network, system 100 indexes friendship and affiliation information. The data structure for facilitating this is a social graph stored in databases 116. Because the social network fundraising system 100 allows people, groups of people, or entities, either to build social networks from scratch or to make use of their existing social networks, during registration a new user can choose to connect to a social networking site/utility, for example LinkedIn or Facebook. Using import function 114, the user can automatically import their contact lists from an email program, for example, using a display interface generated by display generator 110, to find friends who are already registered on the social network fundraising system and invite friends who are not yet registered, or they can manually invite friends to join the social network fundraising system.

Additionally, anybody whom a user invites to join social network fundraising system 100 is added to that user's social graph stored in databases 116: Such invitations are a major source of new users to system 100 and may also help define a social profile in databases 116 of a user based on traits of contacts the user chooses to invite to join the system. Finally, users of social network fundraising system 100 are connected through common “groups” which reflect real-world affiliations they have, such as cities and states where they are located, colleges they have attended, and the companies they have worked for. These groups can be imported automatically from social networking and email programs, or manually created by users when they complete their profiles. Social network fundraising system 100 indexes this information and stores it in the social graph in the collection of databases 116.

Simultaneously, social network fundraising system 100 may create index 118 that arranges a user's information according to the industries in which he, or she, specializes or is affiliated with. This information can be captured from several sources: A user can indicate industries in which she believes herself to have experience or interest; a user can indicate industries applicable to her own fundraising projects; a user can specify an existing structured profile page (e.g., user's LinkedIn profile) from which the social network fundraising system 100 extracts additional industries; and finally, the social network fundraising system observes the user's activity on, and use of, the social network fundraising system, in following or funding projects associated with particular industries. Once the index 118 and social graph in databases 116 for a user are created, the user is now active on system 100 and ready to create her first fundraising project as an entrepreneur.

A entrepreneur begins by creating a business fundraising project, which may also be referred to herein as a “Raise”, typically through a web site of social network fundraising system 100, or through an application user interface, both the web site or the interface preferably generated by display generator 110. The project, or Raise, gets sent to fundraising manager 106. The fundraising manager 106 determines whether the project's information is sufficiently complete and the project has been activated to begin. If so, manager 106 sends the project to project analyzer 104 to ‘understand’, or characterize, the project's traits and provide a project rating based on an algorithm, which may apply various weights to different traits based on inputs from a user interface accessed by the entrepreneur creating the Raise. Project analyzer 104 automatically provides quick, consistent, determinations of a project's characterization and ranking, and fundraising manager 106 displays the project's rating and gives the entrepreneur creating a Raise the opportunity to edit the project.

Fundraising manager 106 simultaneously issues a request to routing engine 108, which accesses index 118 and social graph in databases 116 for a list of potential funders, and ranks them to reflect their estimated likelihood of funding the project. Routing engine 108 returns a ranked list of potential funders to fundraising manager 106, which then contacts the potential funders—one by one, or a few at a time, depending upon funding type or the method chosen by the entrepreneur—and encourages them to view and fund the project, if they would like to provide funding, until the project is fully funded and has reached at least the target funding amount. The entrepreneur can manually engage fundraising manager 106 to contact the potential funders one by one and to invite them to fund the project, or if the project is not set as private (i.e., accessible by invitation only), then the fundraising manager may automatically contact potential funders a few at a time so that they may access the project publicly.

Fundraising manager 106 then forwards any funding offers from the funders to the entrepreneur, and allows the entrepreneur and funder to exchange messages, negotiate any funding terms, and execute the funding transaction through transaction processor 112, which facilitates remote negotiation of a transaction, processes offers and counteroffers, analyzes risks and interest rates when applicable, and automatically updates the users' (both the funder and fundee/entrepreneur) account information stored in the transaction database of databases 116 accordingly.

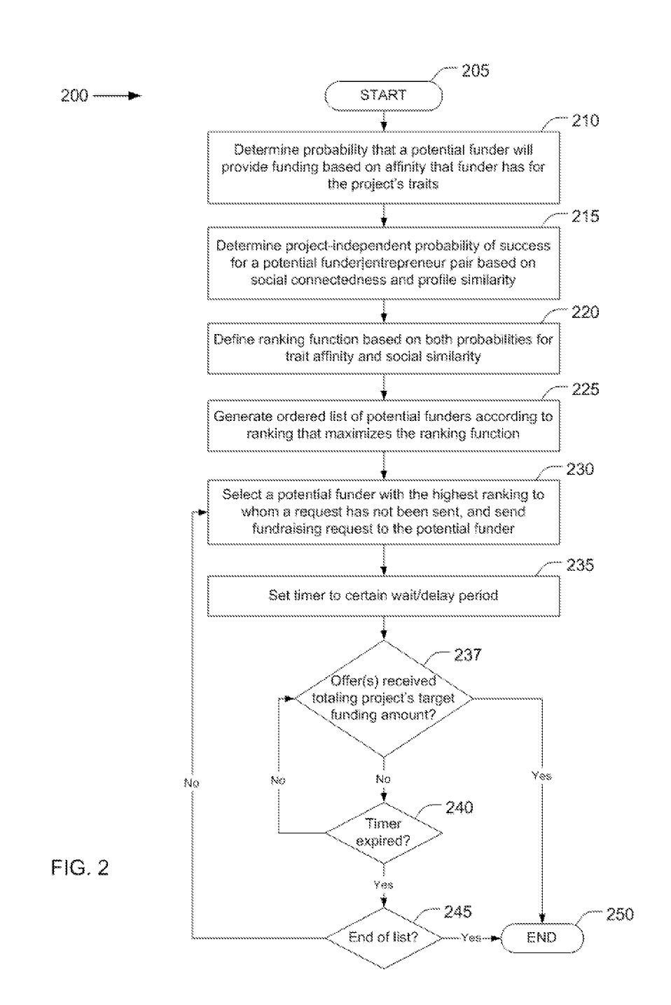

Turning now to FIG. 2, the figure illustrates a flow diagram of a method for using a statistical model and algorithm that generates a relationship ranking corresponding to a relationship between an entrepreneur and a candidate funder. The social network fundraising system model has a number of advantages. It can be applied easily to ventures at all stages, including early-stage ventures such as startups and small businesses that have little or no historical income, debt, or credit. It also allows for matching a very wide range of funders with a long-tail of Raises, thereby increasing funding access to a significantly larger number of ventures than traditionally possible. Furthermore, the social aspect enables users to utilize collaborative trust and filtering in order to weed out risky investments and low-quality ventures.

A theory underlying the efficacy of using a system, as shown in FIG. 1, and the method, as shown in FIG. 2, is that a user will be more likely to fund a Raise if: (1) the Raise possesses those traits that the user associates with greater potential for success, and (2) the user has a positive social connection with the entrepreneur/user creating the Raise.

A comprehensive list of available funding sources is important for funding platforms as project distributions tend to have a long tail. With traditional funding, this is difficult to achieve due to institutional policies and standardized lending criteria. In the social network fundraising system context, the funding sources consist of people rather than institutions, so the methods for acquiring and expanding a comprehensive list of funding sources are quite different. In the social network fundraising system environment, the more active users there are, the more potential funders there are, and therefore the more comprehensive the access to funding. More importantly, because a typical social network fundraising system seeks funders primarily within an entrepreneur user's extended social network, the denser the network, the larger the effective funder base.

In an aspect, a system, such as system 100 shown in FIG. 1, can facilitate generating indicia on a funder's social media persona (e.g., a Facebook or LinkedIn profile) indicating a status that they have funded, and perhaps the extent to which they have funded, a fundee or Raise. For example, a business may permit system 100 to display their logo and a ranking, such as a number of stars, or a color, such as gold, silver, or bronze, on the funder's profile page indicating that they funded the business associated with the logo.

An advantage realized by using a social network fundraising system includes matching a user likely to fund a given project from information associated with another user. In order to do this, a social network fundraising system learns information about users who are potential funders, including: (1) the traits for which she has an affinity and which would make her more likely to fund projects; (2) the users with whom she is connected.

In an aspect, a social network fundraising system computes the distribution of traits known by a user entrepreneur from the following sources of information: users are prompted to provide at least one industry which they believe they have experience or interest in; users are prompted to provide up to three industries that are applicable to their own fundraising projects; the social network fundraising system extracts industries and interests from users' existing online profiles (e.g., LinkedIn accounts, if provided); the social network fundraising system observes the user's activity on its web site, in following and/or funding projects associated with particular industries and interests. The motivation for using these latter sources of profile trait information is a simple one: An entrepreneur typically desires the ability to predict what types of projects a user will fund, and thus an entrepreneur examines the traits of projects a potential funder has funded or created in the past. In this manner, a social network fundraising system uses historical information as an indicator of the traits for which a user has an affinity and which would make her more likely to provide new funding.

In essence, this involves modeling a user as a funding source, with probabilities indicating the likelihood she will fund projects with certain traits. In an aspect, a social network fundraising system computes the social connectedness between users in a number of ways. While social relationship is very important, a system like system 100 as shown in FIG. 1, can evaluate account similarities in demographic information indicated on a potential funder's social media profile. Some factors considered include: relationship, demographic similarity, profile similarity (e.g., common education, work experience), mutual recommendations (e.g., between connected users). Connection strengths between people are computed using weighted averages during run time on a computer device of the social network fundraising system.

Project analyzer 104 determines a list of traits for each Raise representing the profile of the project. It is important to note that in social funding system 100, project analyzer 104 typically only needs to understand the project sufficiently for routing it to likely funders. Thus, the role of the project analyzer 104 in a social funding system is simply to learn enough about the project that it may be sent to interested funders. The list of traits and key mapping criteria—e.g., industries, location, funding type, funding target, private or public, business stage, company structure, previous funding, business plan completed, funding uses, funder rewards, etc.—relevant to a project is produced. The traits used for selecting potential funders, as well as a much larger list of possibly relevant traits, are assigned scores. A social network fundraising system can route a project to someone with relevant traits in her profile.

Based on this list of traits, the project analyzer 104 also generates a project score/rating which is a proprietary meta-trait that can be used for selecting potential funders, as well as used by potential funders for comparing projects and assessing risk.

The social network fundraising system performs ranking with a routing engine 108, which determines an ordered list of users (or “potential funders”) who should be contacted to fund a project, given the entrepreneur and the profile of the project derived by the project analyzer 104. The core ranking function is described by equation 2; essentially, the routing engine 108 can be seen as computing equation 2 for all potential funders, and then sorting the list of potential funders.

The main factors that determine this ranking of users are trait affinity and connectedness. First, the routing engine 108 finds the subset of users who are affinity matches to the project: those users whose profile and activity indicate affinity to the traits which the project has. Users whose profile and activity are closer matches to the project's traits are given higher rank. Second, the routing engine 108 scores each user according to the degree to which she—as a person, independently of her project affinity—is a good “match” for the entrepreneur. The goal of this scoring is to optimize the degree to which the entrepreneur and the funder have a trusting relationship and feel motivated to help each other, based on their sense of connection, similarity, and shared common interests.

Given this ordered list of potential funders, the routing engine 108 then filters out users who should not be contacted, according to opt-out selections, contact preferences, and privacy guidelines. It eliminates users who have opted out of receiving automated email communications regarding new projects seeking funding. Users whose profiles indicate that they have opted out of receiving automated e-mails will be removed from the list of potential funders during automatic routing. However, these users may still be contacted by other users manually inviting them to access/fund the project.

The list of potential funders who survive this filtering process are returned to the fundraising manager 106. The fundraising manager 106 then proceeds with contacting each of them, either one by one or a few at a time, providing them the opportunity to review and fund the present project; and iterating until the Raise has ended due to reaching the target funding amount or due to timeline expiration.

As a funding facilitator, a social network fundraising system allows an entity seeking funding to create a funding request and either forward the request to preselected individuals or entities privately, or make the request publicly available. If a potential funder wishes to contribute funds, it establishes an account and login credentials with the funding facilitator and authorizes a transfer of funds from its account to a payment processor account associated with an entrepreneur at the funding facilitator. The funding facilitator may initiate repayments to funders who are lenders according to a repayment schedule and to proportions that they contributed to the funding amount, and the repayment schedule may reflect interest.

Returning to discussion of FIG. 2, the figure illustrates a flow diagram of a method 200 for determining one or more potential/candidate funders to whom to transmit a fundraising project request message to. Method 200 begins at step 205. At step 210, the method determines a probability p(uᵢ|r), where uᵢ is a potential funder and r is fundraising project. Method 200 determines probability p(uᵢ|r) based on an affinity the potential funder has to traits t associated in a database of a social network fundraising system with the project r. For example, traits of project r might include: the entrepreneur has formed a legal business entity; the project relates to hiring real-estate contractors to build and sell for a profit low-income housing; and the business or project is in a certain geographic region that is near the city/state of uᵢ. If project r is proposed by an entrepreneur who has established a limited liability company, for example, and seeks to build low-income housing, but is not within the preferred geographic region near uᵢ, then the affinity score might be 0.67, assuming equal weighting for each of the three traits given as an example. Eq. 1 shows an exemplary equation for determining p(uᵢ|r):

$$p ( {u}_{i} \vert r ) = {\sum }_{t ∈ T} p ( {u}_{i} \vert t ) p ( t \vert r ) \qquad eq . 1$$

wherein the summation in eq. 1 is performed for one or more traits associated with the project and also for one or more traits associated with the potential funder. For overlapping traits, method 200 preferably only determines the trait affinity once for that particular trait.

At step 220, method 200 determines a probability p(uᵢ|uⱼ), based on degree of social relationship and profile similarity, wherein uᵢ refers to a potential funder and uⱼ refers to the entrepreneur seeking funding. Probabilities p(uᵢ|uⱼ) and p(uᵢ|r) are used to determine ranking function s(uᵢ, uⱼ, r) as shown in eq. 2:

$$s ( {u}_{i} , {u}_{j} , r ) = p ( {u}_{i} \vert {u}_{j} ) \cdot p ( {u}_{i} \vert r ) = p ( {u}_{i} \vert {u}_{j} ) {\sum }_{t ∈ T} p ( {u}_{i} \vert t ) p ( t \vert r ) \qquad eq . 2$$

wherein the summation is performed for one or more traits associated with the project and also for one or more traits associated with the potential funder as discussed above in connection with eq. 1.

Ranking function s(uᵢ, uⱼ, r) considers the social relationship between the entrepreneur uⱼ and the potential funder uᵢ, as well as similarities in their profiles—the more similar the two are based on consideration of social networking profile information, the higher the value for p(uᵢ|uⱼ). Thus, p(uᵢ|uⱼ) biases the result of the ranking function either up or down based on a higher degree of social connectedness and profile similarity or a lower degree of social connectedness and profile similarity, respectively, between the social profiles of the entrepreneur and a particular potential funder.

At step 225, method 200 organizes each record of a list of a plurality of potential funders according to the value determined from ranking function s(uᵢ, uⱼ, r) for each of the funders relative to the entrepreneur and project. Thus, of all records corresponding to potential funders in the potential funder list, the record with the highest ranking would be the one wherein the traits of the project match the most closely with characteristics of the potential funder and wherein the entrepreneur and the particular funder have the most in common socially based on evaluation of a social networking profile, or other similar repository of information, corresponding to the funder.

At step 230, the social network fundraising system sends, or transmits, a message to the highest ranked funder in the potential funder list. The preferred means of transmitting may be gleaned from the potential funder's social networking profile, or profiles, or from any other method that the entrepreneur or system deems appropriate. At step 235, the social network fundraising system sets a timer to a predetermined period. The predetermined period can be the same for every potential funder. Alternatively, the social network fundraising system may determine a value for the wait timer based on the target amount of the fundraising request, or based on information associated with the funder that may have been gleaned from the social networking profile. For example, if the project is for a target amount of $5,000, and the highest-ranked funder has characteristics that he, or she, makes decisions quickly (e.g., they are an executive of a corporation) the timer may be set for one business day. On the other hand, if the target amount requested is $50,000 and the highest-ranked potential funder in the potential funder list is a retiree and director of a non-profit organization where decisions are made by committee, the wait period may be set for three business days.

At step 237, the social network fundraising system computer device determines whether it has received one or more funding offers totaling the target funding amount from the potential funders that it recently sent fundraising project request messages to. If yes, method 200 advances to step 250 and ends. If the determination at step 237 is no, at step 240 the social network fundraising system determines whether the wait timer has expired. If not, method 200 returns to step 237. If the timer has expired, however, method 200 advances to step 245. At step 245, method 200 determines whether the social network fundraising system has sent a fundraising project message to all potential funders on the potential funders list. If yes, method 200 ends at step 250.

If however, there are more potential funders on the potential funders list after the performance of step 245, method 200 returns to step 230 and sends a fundraising project request message to the next-highest-ranked potential funder on the potential funders list to which a request message has not already been sent. Thus, the social network fundraising system sends a fundraising project request first to the potential funder with the highest ranking based on project-dependent trait affinity and project-independent social connectedness between the potential funder and the entrepreneur, and then continues sending requests successively.

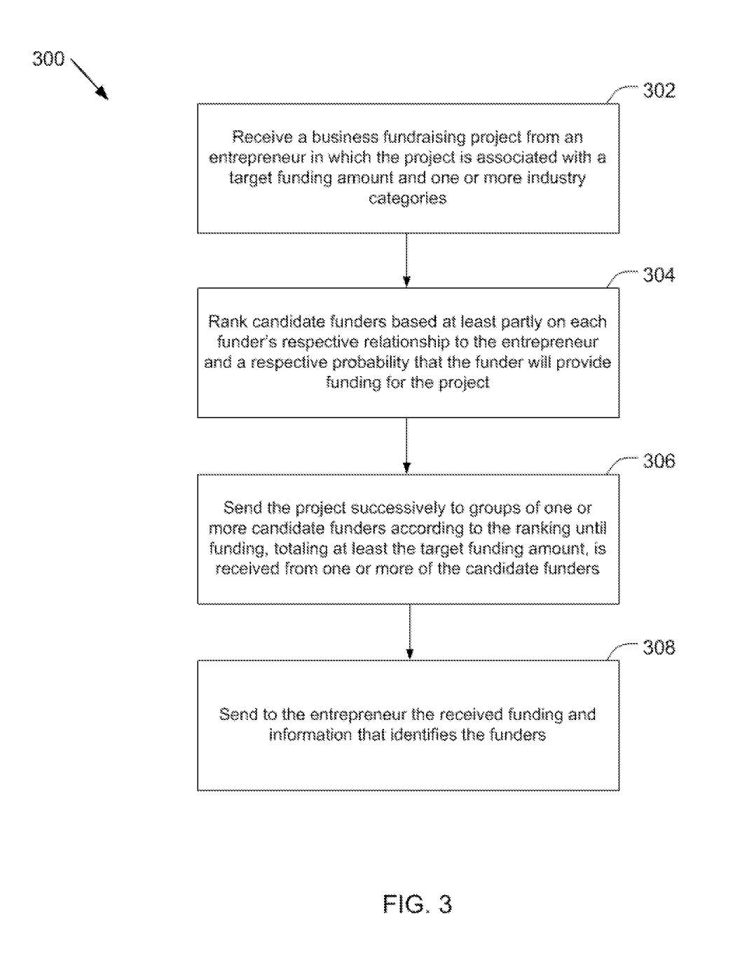

Turning now to FIG. 3, the figure shows a flowchart of a method for providing a fundraising project request to candidate funders. At step 302, a business fundraising project is received, for example, by the fundraising manager 106 shown in FIG. 1, from an entrepreneur in which the project is associated with a target funding amount and one or more industry categories. The industry categories can be determined by the project analyzer 104, for example. At step 304 in FIG. 3, candidate funders are ranked, for example, by the routing engine 108 shown in FIG. 1, based at least partly on each funder's respective relationship to the entrepreneur and a respective probability that the funder will provide funding for the project. At step 306, the project is sent successively to groups of one or more candidate funders, for example, by the fundraising manager 106, according to the ranking until funding offers, totaling at least the target funding amount, is received from one or more of the candidate funders. At step 308, the received funding offers are then sent to the entrepreneur, for example, by the fundraising manager 106, in which the funding offers include information that identifies the funders.

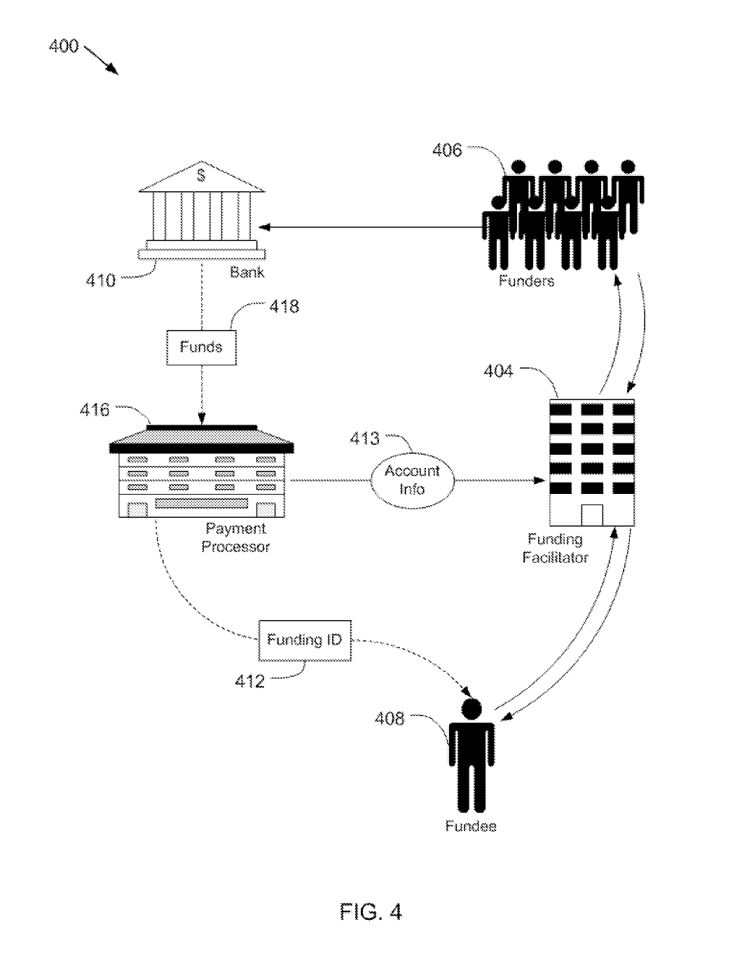

FIG. 4 illustrates a system 400 for initiating a transaction using funds raised in a fundraising transaction. Funding facilitator 404 operates a method accessible over a communications network that facilitates donors, investors, or lenders, giving, investing or lending, money to an entrepreneur 408 via the network. Facilitator 404 may generate a web page, for example, that funders view and use to make donations, loans, or investments. Facilitator 404 provides an interface that allows funders 406 in transferring funds 418 from a personal checking account, for example, to a business checking account associated with an entrepreneur 408 at a bank 410. Furthermore, funds are linked to a funding identifier 412 issued by the payment processor 416 to the entrepreneur 408, and account information 413 is communicated from the payment processor 416 to the facilitator 404. Account information 413 may include, but is not limited to, an account number linked to the business checking account, amount of funds in the account, and contact information of the funders.

In addition, the interface provided by facilitator 404 may impose rules or restrictions on using funds. For example, fundee 408 or funder 406 may impose a maximum transaction amount so that the fundee 408 may not make a single purchase or withdrawal that exceeds the maximum transaction amount.

When fundee 408 withdraws funds from the business account to pay a vendor, for example, he may use the funding identifier 412 issued by payment processor 416. When fundee 408 uses funding identifier 412, payment processor 416 conducts the transfer of funds from bank to vendor according to known methods, such as, for example, electronic funds transfer (EFT). In addition, funding identifier 412 may be used to facilitate multiple forms of payment that processor 416 can handle, including online payment via computer, payment via credit card, payment via mobile telecommunications network, or wire transfer.

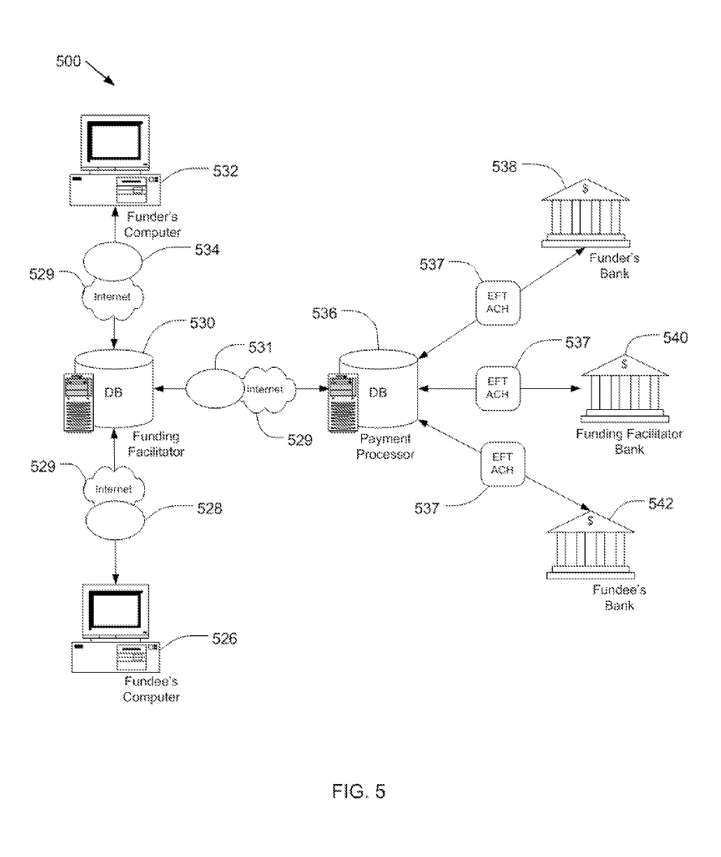

FIG. 5 illustrates a system for facilitating an electronic fund transfer transaction. The figure illustrates an embodiment of system 400 showing how account data and funds data travel between the various entities with the funding facilitator 404 as intermediary. In the illustrated embodiment, fundee 408 uses his computer 526 to login and send, or receive, an account data message 528 over a communication network, such as, for example, the Internet, to, or from, the funding facilitator's database 530. The data message in this case may contain a funding request that the fundee posts on a website that invites his friends and family to provide funding for his business venture.

A funder 406 uses his funder computer 532 to login and send, or receive, an account information message 534 over the communication network to, or from, the funding facilitator's database 530. Account information message 534 may contain a funding request that funder 406 views, and then options that the funder selects from the website in order to provide funding and terms of the funding offer. For example, a funder 406 may select from providing funding as a loan, a donation, or an investment.

The funding facilitator's database 530 can communicate with the fundee's and funders' computers 526 and 532, respectively, via the Internet, for example sending a funder a data message regarding purchases that the fundee has made. The funding facilitator's server, and database 530 can send the fundee an email reminder, or notification, when a loan payment is due.

The funding facilitator's server, and database, 530 also communicates with the payment processor's 416 server, and database, 536, sending and receiving data 531 via a file transfer protocol (“FTP”) data import from the one database to the next. For example, the funding facilitator server/database 530 can import a data log, or report, containing a list of purchases made in one week using the fundee's account, or funding identifier. The report of purchases may also include purchases made by all fundees who use the funding facilitator 404.

The payment processor's server/database 536 may receive, or import, a data message from the funding facilitator 4 in the form of instructions regarding which accounts should be debited or credited and by how much. For example, payment processor server/database 536 may import data from the funding facilitator server/database 530 regarding how much to pay each funder when the fundee makes a loan payment. The amounts may be paid to various funders in proportion to the amounts loaned, as described elsewhere herein.

Payment processor server/database 536 communicates with banks in order to send, or receive funds, via electronic funds transfer-automated clearinghouse (EFT-ACH). In the case of a loan, server/database 536 may generate an EFT-ACH transaction message 537 that debits funds from a funder's bank account at bank 538, places a five percent (for example) commission from the debited funds in the funding facilitator's bank account at bank 540 as a service fee, and then credits the remaining funds to fundee's account at fundee's bank 542. Alternatively, in case of a loan in repayment, server/database 536 may communicate the appropriate account numbers to banks 538, 540, and 542, and withdraw funds from fundee's bank 542, place a two percent (for example) service fee, or commission, in the funding facilitator's bank 540 bank account, and then deposit the remaining funds to funder's bank account at bank 538. Finally, payment processor server/database 536 relays a repayment transaction message containing information regarding the repayment to funding facilitator's server/database 530 during the next FTP data import.

What is claimed is:

1. A method performed by a computer device, the method comprising:
receiving a business fundraising project request from an entrepreneur (or an agent of the entrepreneur) in which the request is associated with one or more traits;
selecting candidate funders based on a relationship rank of the funder with respect to the entrepreneur;
sending the request to one or more groups of one or more candidate funders successively and preferentially according to the relationship ranking until funding offers are received from one or more of the candidate funders; and
sending to the entrepreneur (or agent) the received funding offers and information that describes the one or more funders from which a funding offer was received and from the candidate funders which did not provide a funding offer.

2. The method of claim 1 in which selecting candidate funders is based on whether the candidate funder has been contacted during a recent predetermined period or according to a contact frequency preference of the candidate funder.

3. The method of claim 1 further comprising receiving from a candidate funder an identification of another potential funder and sending the project request to the other candidate funder.

4. The method of claim 1 in which the relationship rank of a candidate funder to the entrepreneur is based on a measurement of social interaction between the candidate funder and the entrepreneur.

5. The method of claim 1 in further comprising selecting one or more message formats appropriate for the one or more candidate funders the one or more groups of one or more candidate funders and sending the project request using the selected message formats.

6. The method of claim 5 in which a message format is an HTML/XML electronic mail, a plain text electronic mail for viewing on mobile devices, an instant message, a text message via mobile SMS, an online post, or other social network message.

7. The method of claim 5 wherein the message format for a candidate funder in the one or more groups of one or more candidate funders is selected based at least partly on a likelihood that the candidate funder will provide a funding offer based on the message format.

8. The method of claim 1 in which the information includes ranking factor values describing and corresponding to a relationship between the entrepreneur and each funder.

9. The method of claim 1 in which traits include one or more of: target funding amount, industry category, location, interests, previous funding, activity, status of private or public, business stage, company structure, business plan completion status, uses of funding, rewards offered to funders, project rating/score, and funding type, wherein the funding type includes at least one of gift, donation, loan, commercial paper, and equity investment.

10. The method of claim 1 in which selecting candidate funders further comprises selecting one or more candidate funders based on traits associated with the selected candidate funders.

11. The method of claim 10 in which traits include one or more of: target funding amount, industry category, location, interests, previous funding, activity, status of private or public, business stage, company structure, business plan completion status, uses of funding, rewards offered to funders, project rating/score, and funding type, wherein the funding type includes at least one of gift, donation, loan, commercial paper, and equity investment.

12. The method of claim 1 wherein the computer device waits a request delay period between the sending of a fundraising project request to a candidate funder corresponding to a current request and a successive candidate funder based on the relationship ranking of the requestor and the funder corresponding to the current request.

13. The method of claim 1 wherein the computer device waits a request delay period between the sending of a funding request to a candidate funder corresponding to a current request and a successive candidate funder based on the target amount of the fundraising project request.

14. A computer system configured for performing steps comprising: receiving a business fundraising project request from an entrepreneur (or an agent of the entrepreneur) in which the request is associated with one or more traits; selecting candidate funders based at least partly on each funder's respective relationship to the entrepreneur; sending the request successively to groups of one or more candidate funders until funding offers are received from one or more of the candidate funders; and sending to the entrepreneur (or agent) the received funding offers and information that identifies the actual funders or candidate funders.

15. The system of claim 14 in which selecting candidate funders is based at least partly on whether the candidate funder has been contacted in a recent time period or a contact frequency preference of the candidate funder.

16. The system of claim 14 in which sending further comprises receiving from a candidate funder identification of another potential funder and sending the project to the other candidate funder.

17. The system of claim 14 in which the respective relationship of a candidate funder to the entrepreneur is based at least partly on a measurement of social interaction between the candidate funder and the entrepreneur.

18. The system of claim 14 in which sending further comprises selecting one or more message formats appropriate for the one or more candidate funders in the group and sending the project using the selected message formats.

19. The system of claim 18 in which a message format is an HTML/XML electronic mail, a plain text electronic mail for viewing on mobile devices, and instant message, a text message via mobile SMS, an online post, or other social network message.

20. The system of claim 18 in which the message format for a candidate funder in the group is selected based at least partly on a likelihood that the candidate funder will provide a funding offer based at least partly on the message format.

21. The system of claim 14 in which the information includes a description of a relationship between the entrepreneur and each funder.

22. The system of claim 14 in which traits include one or more of: target funding amount, industry category, location, interests, previous funding, activity, status of private or public, business stage, company structure, business plan completion status, uses of funding, rewards offered to funders, project rating/score, and funding type, wherein the funding type includes at least one of gift, donation, loan, commercial paper, and equity investment.

23. The system of claim 14 in which selecting candidate funders further comprises selecting one or more candidate funders based on traits associated with the selected candidate funders.

24. The system of claim 23 in which traits include one or more of: target funding amount, industry category, location, interests, previous funding, activity, status of private or public, business stage, company structure, business plan completion status, uses of funding, rewards offered to funders, project rating/score, and funding type, wherein the funding type includes at least one of gift, donation, loan, commercial paper, and equity investment.

25. A computer-readable medium including instructions for causing a computer and data processing apparatus to perform operations comprising: receiving a business fundraising project request from an entrepreneur in which the request is associated with one or more traits; selecting candidate funders based at least partly on each funder's respective relationship to the entrepreneur; sending the request successively to groups of one or more candidate funders until funding offers are received from one or more of the candidate funders; and sending to the entrepreneur the received funding offers and information that identifies the actual funders or candidate funders.
